(19) United States
(12) Patent Application Publication
(10) Pub. No.: US 2019/0275477 A1
(43) Pub. Date: Sep. 12, 2019

(54) APPARATUS AND METHOD FOR PRODUCING FINE AIR BUBBLE MIXED LIQUID

(71) Applicant: NISSIN GIKEN CO., LTD., Higashiosaka-shi, Osaka (JP)

(72) Inventors: Shinichi YAMAMOTO, Higashiosaka-shi, Osaka (JP); Kenichi YAMAMOTO, Higashiosaka-shi, Osaka (JP)

(21) Appl. No.: 16/302,513

(22) PCT Filed: May 23, 2017
(86) PCT No.: PCT/JP2017/019156

§ 371 Date: Nov. 16, 2018

(30) Foreign Application Priority Data
May 24, 2016 (JP) 2016-103475

(51) Int. Cl. B01F 3/04; B01F 5/10; B01F 7/28; B01F 7/18

(52) U.S. Cl. CPC B01F 3/04609; B01F 3/0451; B01F 7/18; B01F 5/106; B01F 7/285; B01F 5/104

(57) ABSTRACT

A fine-bubble mixed liquid producing apparatus 1 includes a reservoir 4 and a bubble feeding means 6 for feeding bubbles to a liquid L stored in the reservoir 4, wherein the bubble feeding means 6 includes a rotary cylinder 20 having an emitting part 22 on the outer circumferential surface, the emitting part 22 for being rotationally driven by a drive means 10, a circulating means 40 for drawing out the liquid L stored in the reservoir 4 and feeding the liquid L from the emitting part 22 to the reservoir 4, and a gas-liquid mixing part 50 for mixing bubbles with the liquid L circulated by the circulating means 40. This apparatus enables a fine-bubble mixed liquid to be efficiently produced.

### TECHNICAL FIELD

The present invention relates to an apparatus and a method for producing a fine-bubble mixed liquid.

### BACKGROUND ART

To date, apparatuses are known that reduce the size of bubbles and mix such bubbles with a liquid in order to promote, for example, dissolution of a gas. A nozzle is a known means for producing fine bubbles, but since there is a limit to reducing the bubble size by way of reducing the nozzle diameter, for example, in Patent Literature 1, the size of bubbles to be fed to a liquid is reduced by compressing the bubbles by rotating rotary blades.

### CITATION LIST

### Patent Literature

Patent Literature 1: JP 2001-104764A

### SUMMARY OF INVENTION

### Technical Problem

However, the gas-liquid mixer disclosed in Patent Literature 1 requires rotary blades to be rapidly rotated in order to compress and mix gas and liquid, and thus there is a possibility that the rotational resistance is increased and that the load on the power source becomes excessive.

Accordingly, an object of the present invention is to provide an apparatus and a method for producing a fine-bubble mixed liquid, which are capable of efficiently producing a liquid mixed with fine bubbles.

### Solution to Problem

The object of the present invention is achieved by a fine-bubble mixed liquid producing apparatus comprising a reservoir and a bubble feeding means for feeding bubbles to a liquid stored in the reservoir, wherein

the bubble feeding means comprises:
a rotary cylinder having an emitting part on an outer circumferential surface, wherein the rotary cylinder is for being rotationally driven by a drive means,
a circulating means for drawing out the liquid stored in the reservoir and feeding the liquid from the emitting part to the reservoir, and
a gas-liquid mixing part for mixing bubbles with the liquid circulated by the circulating means, and

by immersing the emitting part in the liquid stored in the reservoir and rotating the rotary cylinder, a bubble-mixed liquid is emitted from the emitting part, and a fine-bubble mixed liquid is thus produced.

It is preferable that the rotary cylinder comprises rotary blades inside. It is more preferable that the rotary blades are disposed in a lower part of the rotary cylinder.

It is preferable that the fine-bubble mixed liquid producing apparatus further comprises an outer cylinder disposed coaxially with the rotary cylinder such that there is a space between the outer cylinder and the outer circumferential surface of the rotary cylinder.

Moreover, the object of the present invention is achieved by a method for producing a fine-bubble mixed liquid by mixing bubbles with a liquid stored in a reservoir, wherein a rotary cylinder having an emitting part on an outer circumferential surface is suspended; the rotary cylinder is rotated, with the emitting part being immersed in the liquid in the reservoir; the liquid in the reservoir is drawn out, mixed with bubbles, and then emitted from the emitting part; and the fine-bubble mixed liquid is thus produced.

### Advantageous Effects of Invention

The present invention can provide an apparatus and a method for producing a fine-bubble mixed liquid, which are capable of efficiently producing a liquid mixed with fine bubbles.

### BRIEF DESCRIPTION OF DRAWINGS

FIG. 1 is a vertical cross-sectional view of a fine-bubble mixed liquid producing apparatus according to one embodiment of the present invention.

FIG. 2 is an exploded perspective view of a relevant part of the fine-bubble mixed liquid producing apparatus shown in FIG. 1.

FIG. 3 is an enlarged view of a relevant part, showing a state during operation of the fine-bubble mixed liquid producing apparatus shown in FIG. 1.

FIG. 4 is a vertical cross-sectional view of a fine-bubble mixed liquid producing apparatus according to another embodiment of the present invention.

FIG. 5 is a side view of a relevant part of a fine-bubble mixed liquid producing apparatus according to yet another embodiment of the present invention.

### DESCRIPTION OF EMBODIMENTS

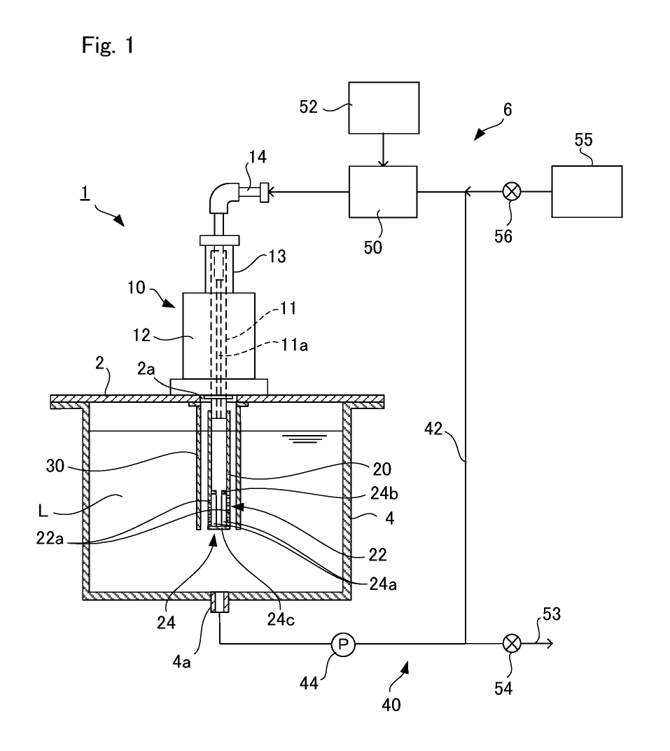

Below, an embodiment of the present invention will now be described with reference to the attached drawings. FIG. 1 is a vertical cross-sectional view of a fine-bubble mixed liquid producing apparatus according to one embodiment of the present invention. As shown in FIG. 1, a fine-bubble mixed liquid producing apparatus 1 includes a reservoir 4 for storing a liquid L and a bubble feeder 6 for feeding bubbles to the liquid L in the reservoir 4.

The bubble feeder 6 includes a drive motor 10 fixed to the upper surface of a support plate 2 placed over the upper opening of the reservoir 4, a circular rotary cylinder 20 for being rotationally driven by the drive motor 10, an outer cylinder 30 suspended from the support plate 2 so as to accommodate the rotary cylinder 20, a circulator 40 for circulating the liquid stored in the reservoir 4, and a gas-liquid mixing part 50 for mixing bubbles with the liquid L circulated by the circulator 40. While the support plate 2 is disposed so as to hermetically close the reservoir 4 in the present embodiment, the support plate 2 may be configured to allow the inside and the outside of the reservoir 4 to be in communication. A weak electric current may be applied to the liquid L stored in the reservoir 4 by an ore, battery, or the like provided inside or outside the reservoir 4.

The drive motor 10 is configured such that the upper and lower ends of an output shaft 11 project from a casing 12. The output shaft 11 has an introduction path 11a that axially penetrates the central part. The upper end of the output shaft 11 is connected to an introduction part 14 via a rotary joint 13 in an airtight and relatively rotatable manner.

The lower end of the output shaft 11 extends through a through-hole 2a formed in the support plate 2, is securely connected to the upper end of the rotary cylinder 20, supports the rotary cylinder 20 so as to suspend the rotary cylinder 20, and rotationally drives the rotary cylinder 20. The rotary cylinder 20 is made of, for example, a metallic material such as stainless steel, and has an emitting part 22 composed of a plurality of emitting holes 22a in the outer circumferential surface of the lower part. The emitting holes 22a are formed at circumferentially equal intervals so as to uniformly discharge therearound a gas-liquid mixture introduced into the rotary cylinder 20 from the introduction path 11a of the output shaft 11 and, moreover, are also formed at axially equal intervals such that the emitting part 22 has a predetermined height (e.g., about 150 mm). The diameter of the emitting holes 22a is not particularly limited and is, for example, 0.1 to 1.5 mm. The rotary cylinder 20 preferably has a smooth outer circumferential surface without having stirring blades or the like.

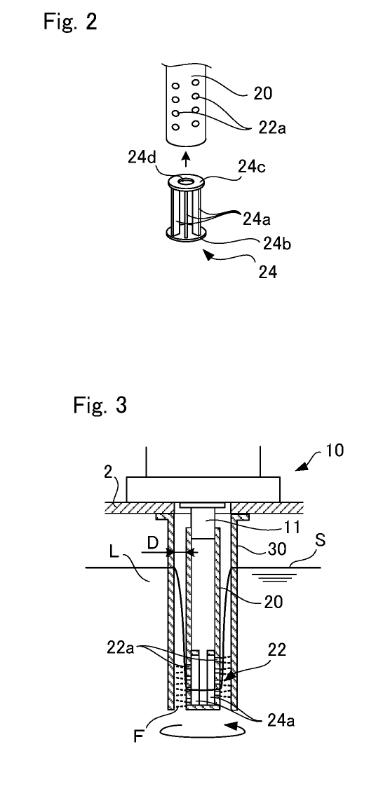

A stirring member 24 is provided inside the lower part of the rotary cylinder 20. As shown in the exploded perspective view of FIG. 2, the stirring member 24 has a plurality of flat rotary blades 24a on a lower disc 24b having substantially the same diameter as the outer diameter of the rotary cylinder 20. In the case of providing a large number of the rotary blades 24a, it is preferable that the rotary blades 24a are radially disposed at equal intervals. An upper disc 24c having substantially the same diameter as the inner diameter of the rotary cylinder 20 is attached to the upper part of the rotary blade 24a. As indicated by the arrow in FIG. 2, the stirring member 24 is inserted from below the rotary cylinder 20 such that each rotary blade 24a is positioned between the circumferentially adjacent emitting holes 22a, and is fixed to the rotary cylinder 20 such that the lower disc 24b closes the lower opening of the rotary cylinder 20. The upper disc 24c has a communication hole 24d in the center, and a gas-liquid mixture introduced into the rotary cylinder 20 travels through the communication hole 24d, is stirred by the rotary blades 24a, and is emitted from the emitting holes 22a. The shape and the arrangement of the rotary blades 24a are not particularly limited as long as the rotary blades 24a are capable of producing a swirling flow inside the rotary cylinder 20. For example, curved, spiral, or airfoil-shaped rotary blades may be used in place of the flat rotary blades 24a.

The outer cylinder 30 is in the form of a straight cylinder made of a resin such as acryl or a metal such as stainless steel, and is disposed coaxially with the rotary cylinder 20 such that there is a space between the outer cylinder 30 and the outer circumferential surface of the rotary cylinder 20. The upper end of the outer cylinder 30 is fixed to the support plate 2. The lower end of the outer cylinder 30 substantially matches the lower end of the inner cylinder 20, and the emitting part 22 of the rotary cylinder 20 is covered by the outer cylinder 30. A helical guide plate (not shown) may be provided on the inner circumferential surface of the outer cylinder 30 so as to facilitate a swirling flow of the liquid L inside the outer cylinder 30.

The circulator 40 includes a pipe 42 connecting a discharge port 4a formed in the bottom of the reservoir 4 and the introduction part 14, and a circulation pump 44 that is disposed in the middle of the pipe 42 and draws out the liquid L in the reservoir 4 to the outside of the reservoir 4. The gas-liquid mixing part 50 is disposed in the middle of the pipe 42 more toward the downstream side than the circulation pump 44 is, and mixes the liquid L traveling inside with a pressurized gas fed from a gas feeder 52 such as a compressor or a gas cylinder.

The configuration of the gas-liquid mixing part 50 is not particularly limited, and may be of, for example, a pore blowing type in which bubbles are mixed with a liquid via pores of a porous film, a swirling flow type in which gas and liquid are rapidly swirled and mixed, or a Venturi type in which gas is introduced by utilizing the negative pressure generated by the traveling of the liquid L. Also, the gas-liquid mixing part 50 can be also configured to suck outside air and mix it with the liquid L without having the gas feeder 52. The gas-liquid mixture discharged from the gas-liquid mixing part 50 is fed to the reservoir 4 from the emitting part 22 of the rotary cylinder 20. Moreover, the gas-liquid mixing part 50 may be configured to include a liquid electrolyzer that produces bubbles by electrolyzing a liquid, and in this configuration, the produced bubbles may be fed to the pipe 42 as a mixture with a non-electrolyzed liquid. In the case of producing bubbles by a liquid electrolyzer, the liquid electrolyzer may be used in combination with the gas feeder 52, but the configuration that does not involve the gas feeder 52 can save energy.

A branch pipe 53 is connected to the pipe 42 constituting the circulation path, and by regulating the opening of an on-off valve 54 provided in the middle of the branch pipe 53, some of the gas-liquid mixture flowing through the pipe 42 can be continuously drawn out from the branch pipe 53. Also, the pipe 42 is configured to be capable of receiving the liquid L from a liquid feeder 55, and by regulating the opening of an on-off valve 56, the pipe 42 can be continuously replenished with the liquid L corresponding to the amount of liquid discharged from the branch pipe 53. The pipe 42 may be configured to include a magnetic treatment part for imparting a magnetic field to the inside of the pipe 42 using a permanent magnet or the like, and it is thus possible to enhance the ability to retain fine bubbles by magnetic treatment of the liquid.

Next, the operation of the fine-bubble mixed liquid producing apparatus 1 having the above configuration will now be described. As shown in FIG. 1, the liquid L such as water is stored in the reservoir 4, and substantially the entirety of the rotary cylinder 20 is immersed in the liquid. Then, activating the drive motor 10 and the circulation pump 44 causes the rotary cylinder 20 to be axially rotated together with the rotary blades 24a as indicated by the arrow in FIG. 3, and the gas-liquid mixture introduced into the rotary cylinder 20 from the circulator 40 becomes a swirling flow due to the rotary blades 24a and is discharged from the emitting part 22.

When the rotary cylinder 20 is rapidly rotated, a liquid surface S of the liquid L is depressed in a bowl-like shape, with the rotary cylinder 20 being in the center, and the liquid surface S around the rotary cylinder 20 is lowered to the vicinity of the emitting part 22 and moves up and down there. Accordingly, a jet flow F of the gas-liquid mixture discharged from each emitting hole 22a is stirred while colliding with the liquid surface S and incorporated into the liquid, and therefore the bubbles become finer and spread over the liquid L. Faster the rotation of the rotary cylinder 20, the greater the lowering of the liquid surface S resulting from the rotation of the rotary cylinder 20, and it is therefore preferable to regulate the rotational speed of the rotary cylinder 20 such that the liquid surface S is maintained in the vicinity of the emitting part 22 (e.g., at 3600 to 15000 rpm, or 15000 rpm or greater). It is preferable to suitably set the space (distance D in FIG. 2) created between the rotary cylinder 20 and the outer cylinder 30 so as to facilitate the desired lowering of the liquid surface S. For example, the space is 10 to 20 mm or 20 mm or greater.

Thus, according to the fine-bubble mixed liquid producing apparatus 1 of the present embodiment, a gas-liquid mixture discharged from the emitting part 22 due to the rotation of the rotary cylinder 20 is mixed with the liquid L while slicing the liquid, and it is thus possible to efficiently produce a fine-bubble mixed liquid containing fine bubbles such as microbubbles or nanobubbles.

Also, since the rotary blades 24 are radially disposed so as to extend from the inner circumferential surface of the rotary cylinder 20 toward the center, the rotary cylinder 20 can suppress an increase of rotational resistance in comparison to the case where the rotary blades are provided on the outer circumferential surface of the rotary cylinder 20, and can save electric power.

One embodiment of the present invention has been described in detail above, but the specific aspects of the present invention are not limited to the above embodiment. For example, the gas to be supplied to the gas-liquid mixing part 50 may be oxygen, ozone, carbon dioxide, nitrogen, hydrogen, or the like other than air, and these gases can be fed from the gas feeder 52 and retained as ultrafine bubbles in the liquid for a long period of time. For example, a fine-bubble mixed liquid that contains oxygen as fine bubbles in water can be suitably used for disinfection and sterilization.

As for the liquid L, a substance other than water can be suitably selected according to the application, and the liquid L preferably has a low temperature (e.g., 10° C. or lower) in order to maintain fine bubbles for a long period of time. In order to maintain the liquid L in the reservoir 4 at a low temperature, a refrigerating heat exchanger may be disposed around the reservoir 4 or immersed in the liquid L of the reservoir 4.

While the outer cylinder 30 is disposed so as to facilitate creating the desired bowl-like shape of the liquid surface S when the rotary cylinder 20 is rotated in the foregoing embodiment, the outer cylinder 30 is not an essential component, and, for example, in the case where the reservoir 4 is a small cylinder, no outer cylinder 30 may be provided.

While the introduction path 11a for introducing the gas-liquid mixture into the rotary cylinder 20 is formed in the output shaft 11 of the drive motor 10 to thereby enable the gas-liquid mixture to be stably emitted from the emitting part 22 in the foregoing embodiment, the introduction path 11a may be elsewhere other than in the output shaft 11, and the gas-liquid mixture may be introduced from the upper part or the lateral part of the rotary cylinder 20 via a mechanical seal or the like.

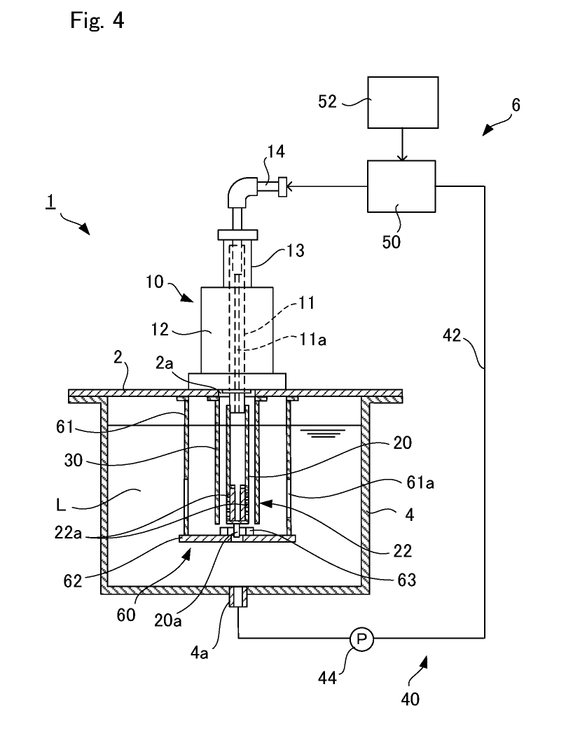

As shown in FIG. 4, the fine-bubble mixed liquid producing apparatus 1 may further include a support member 60 for rotatably supporting the lower end of the rotary cylinder 20. The support member 60 includes a retainer plate 62 at the lower end of the support cylinder 61, the retainer plate 62 has a sliding bearing 63, and a distal end 20a of the rotary cylinder 20 is supported by the sliding bearing 63. A communication hole 61a for allowing the liquid L to flow between inside and outside is suitably formed in the support cylinder 61. According to this configuration, the rotary cylinder 20 can be more stably rotated, and a desired fine-bubble mixed liquid can be easily produced.

While the fine-bubble mixed liquid producing apparatus 1 shown in FIG. 1 is configured such that the fine-bubble mixed liquid can be continuously drawn out from the branch pipe 53, the fine-bubble mixed liquid producing apparatus 1 may have a batch-type configuration wherein the pipe 42 serving as a circulation path does not include the branch pipe 53 as shown in FIG. 4.

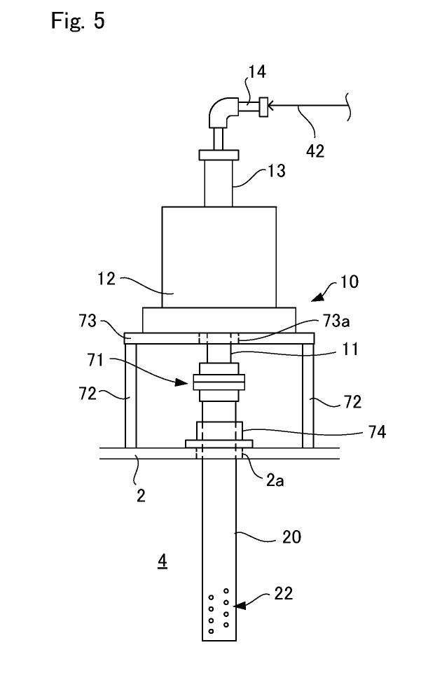

While the rotary cylinder 20 is directly connected to the output shaft 11 of the drive motor 10 in the fine-bubble mixed liquid producing apparatus 1 shown in FIG. 1, the output shaft 11 and the rotary shaft 20 may be connected via a shaft coupling 71 as shown in the side view of a relevant part in FIG. 5. In this configuration, by providing a base plate 73 above the upper surface of the support plate 2 via a plurality of support columns 72 and forming a through-hole 73a, into which the output shaft 11 is inserted, in the base plate 73, the casing 12 of the drive motor 10 can be placed on the base plate 73. In order to maintain the airtight state inside the reservoir 4, it is preferable to provide a through-shaft seal 74, into which the rotary shaft 20 is inserted in an airtight manner, in the through-hole 2a of the support plate 2.

According to the configuration shown in FIG. 5, providing the shaft coupling 71 makes it easy to disconnect the inside of the reservoir 4 and the pipe 42, and thus maintainability can also be enhanced.

### REFERENCE SIGNS LIST

1 Fine-bubble mixed liquid producing apparatus
4 Reservoir
6 Bubble feeder
10 Drive motor
20 Rotary cylinder
22 Emitting part
24a Rotary blade
30 Outer cylinder
40 Circulator
50 Gas-liquid mixing part
60 Support member
L Liquid

1. A fine-bubble mixed liquid producing apparatus comprising a reservoir and a bubble feeding means for feeding bubbles to a liquid stored in the reservoir, wherein
the bubble feeding means comprises:
a rotary cylinder having an emitting part on an outer circumferential surface, wherein the rotary cylinder is for being rotationally driven by a drive means,
a circulating means for drawing out the liquid stored in the reservoir and feeding the liquid from the emitting part to the reservoir, and
a gas-liquid mixing part for mixing bubbles with the liquid circulated by the circulating means, and
by immersing the emitting part in the liquid stored in the reservoir and rotating the rotary cylinder, a bubble-mixed liquid is emitted from the emitting part, and a fine-bubble mixed liquid is thus produced.

2. The fine-bubble mixed liquid producing apparatus according to claim 1, wherein the rotary cylinder comprises rotary blades inside.

3. The fine-bubble mixed liquid producing apparatus according to claim 1, further comprising an outer cylinder disposed coaxially with the rotary cylinder such that there is a space between the outer cylinder and an outer circumferential surface of the rotary cylinder.

4. A method for producing a fine-bubble mixed liquid by mixing bubbles with a liquid stored in a reservoir, wherein
a rotary cylinder having an emitting part on an outer circumferential surface is suspended; the rotary cylinder is rotated, with the emitting part being immersed in the liquid in the reservoir; the liquid in the reservoir is drawn out, mixed with bubbles, and then emitted from the emitting part; and the fine-bubble mixed liquid is thus produced.

5. The fine-bubble mixed liquid producing apparatus according to claim 2, further comprising an outer cylinder disposed coaxially with the rotary cylinder such that there is a space between the outer cylinder and an outer circumferential surface of the rotary cylinder.
